(19) United States
(12) Patent Application Publication
(10) Pub. No.: US 2009/0258627 A1
(43) Pub. Date: Oct. 15, 2009

(54) RECEIVING CIRCUIT, USE, AND METHOD FOR RECEIVING IN A RADIO NETWORK

(76) Inventors: Thomas HANUSCH, Coswig (DE); Sascha BEYER, Medingen (DE); Tilo FERCHLAND, Dresden (DE)

Correspondence Address: Muncy, Geissler, Olds & Lowe, PLLC, P.O. BOX 1364, FAIRFAX, VA, 22038-1364, US

(21) Appl. No.: 12/423,622

(22) Filed: Apr. 14, 2009

Related U.S. Application Data
(60) Provisional application No. 61/045,762, filed on Apr. 17, 2008.

(30) Foreign Application Priority Data
Apr. 14, 2008 (DE) DE 102008018869.7

(51) Int. Cl. H04B 1/06

(52) U.S. Cl. 455/277.1

(57) ABSTRACT

A receiving circuit, use, and method for receiving in a radio network is provided, wherein switching is performed continuously between a first signal, which is received over a first antenna, and a second signal, which is received over a second antenna, to form an input signal. The input signal is converted analog/digitally into a digital signal, the digital signal is correlated to output a correlation signal, the correlation signal is compared with a threshold, and the switching for data reception in a current switch position is stopped when the correlation signal exceeds the threshold.

This nonprovisional application claims priority to German Patent Application No. DE 10 2008 018 869.7, which was filed in Germany on Apr. 14, 2008, and to U.S. Provisional Application No. 61,045,762, which was filed on Apr. 17, 2008, and which are both herein incorporated by reference.

### BACKGROUND OF THE INVENTION

1. Field of the Invention

The present invention relates to a receiving circuit, a use, and a method for receiving in a radio network.

2. Description of the Background Art

Modern receiving circuits for high-frequency radio signals for use in local radio networks are characterized by a very high sensitivity. Different radio networks at the same transmission frequency can interfere with each other. With an increasing density of the radio networks, this can result in increasingly worsening transmission conditions. Radio networks of this type are described, for example, in industry standards IEEE 802.11, IEEE 802.15.1, or IEEE 802.15.4, which sometimes utilize the same frequency bands.

### SUMMARY OF THE INVENTION

It is therefore an object of the present invention to provide as improved a receiving method as possible in a radio network.

This object is achieved by the method with the features of independent claim 1. Advantageous refinements are the subject of dependent claims and included in the description.

Accordingly, a method for receiving in a radio network is provided. In the method, switching is performed continuously between a first signal, which is received over a first antenna, and a second signal, which is received over a second antenna, to form an input signal. In addition, a third antenna with a third signal can be provided, which is integrated into the switching process. Switching is alternated, in contrast, in the case of only two antennas.

The input signal is converted analog/digitally into a digital signal. Filtering and/or amplification are preferably provided before the analog-to-digital conversion.

The digital signal is correlated to output a correlation signal. In so doing, advantageously, the digital signal is correlated with itself (autocorrelation) or with a predefined signal (cross-correlation). The correlation signal is an output signal of the correlation and indicates an extent of matching.

The correlation signal is compared with a threshold. Preferably, the threshold is a constant threshold value, which is advantageously programmable.

The switching for data reception in a current switch position is stopped when the correlation signal exceeds the threshold. For this reason, the signal path of the particular antenna is held in the switch position of the switching device in which the correlation signal precisely of said antenna exceeds the threshold.

The object of the invention furthermore is to improve a receiving circuit of a radio network as much as possible.

Said object is achieved by a receiving circuit with the features of independent claim 8. Advantageous refinements are the subject of dependent claims and included in the description.

Accordingly, a receiving circuit of a radio network is provided. The receiving circuit has a first input, which to receive a first signal is connectable to a first antenna, and a second input, which to receive a second signal is connectable to a second antenna. Preferably, the first input and the second input are terminals of a monolithically integrated circuit.

Preferably, the receiving circuit has a switching device, which is connected directly or indirectly to the first input and the second input for switching between the first signal and the second signal, so that the first signal and the second signal reach a switching device via a respective connection. For the direct connection, an electrical conductor is advantageously formed between the input and the switching device. Alternatively, it is possible in principle to provide in each case an amplifier or a filter for a direct connection between each input and the switching device.

Preferably, the receiving circuit has an analog-to-digital converter, which is formed to convert the first signal or the second signal into a digital signal depending on the switch position. In so doing, the signal just put through by the switching device is converted.

Preferably, the receiving circuit has a synchronization device, which is formed to correlate the digital signal to output a correlation signal.

Preferably, the receiving circuit has a digital comparator which is formed to compare the correlation signal with a threshold. The threshold is advantageously programmable as a register value. Alternatively, the threshold can be calculated or is unmodifiable as a fixed value.

Preferably, the receiving circuit has a control circuit which is connected to the switching device and the comparator. Preferably, the control circuit is formed to control the switching device for continuous switching between the first signal and the second signal. It is also preferable that the control circuit is formed to stop the switching when the correlation signal exceeds the threshold.

Preferably, the switching device, the analog-to-digital converter, the synchronization device, the comparator, and the control circuit are integrated monolithically on a semiconductor chip.

Preferably, the receiving circuit is formed and set up to carry out the previously described process.

The invention furthermore has the object of providing a use.

This object is achieved by a use with the features of independent claim 10. Advantageous refinements are the subject of dependent claims and given in the description.

Accordingly, a use of a synchronization device and a comparator of a receiving circuit of a radio network is provided. The synchronization device and the comparator are used for comparing a result of a correlation with a threshold and to stop a continuing switching between at least two signals of different antennas. In this regard, the stopping of the continuous switching occurs when the result of the correlation exceeds the threshold.

The refinements described hereinafter relate to the receiving circuit, as well as to the use and to the receiving method. Advantageously, the receiving circuit in this regard is formed and set up for the process steps.

In an advantageous embodiment, a preamble is transmitted which is used for correlation in the receiving circuit. Preferably, a time period between two switchings is shorter than a transmission time for the preamble. Especially preferably, the time period between two switchings is shorter than half of the transmission time for the preamble.

According to an advantageous refinement, the switching is cyclic. The time intervals between two switchings are preferably equal during the cyclic switching. Under certain conditions, one can depart from these cyclic switching.

According to an especially advantageous refinement, a time period between two switchings is lengthened when a determined current received power exceeds an additional threshold. The received power can be determined, for example, as a received field strength. The additional threshold thereby can be set independently, particularly programmed. This is based on the realization that the probability for receiving a valid signal increases when there is a significantly high received power of a received signal.

In an advantageous refinement, the switching is stopped after the threshold is exceeded until it is determined that the transmitted data are complete. The completeness is preferably determined in that a data frame is completely loaded into the memory. The frame length is advantageously determined from the data of the frame itself. Preferably, in the case of completeness, a control signal is generated and applied at the control circuit to initiate the switching process.

According to an alternative refinement, which can also be combined with a completeness check, the switching is stopped after the threshold is exceeded depending on a time switch. The time switch is, for example, a timer or a monoflop. The time switch is started, for example, by validity information (SFD) in the frame.

Preferably, the synchronization device has a correlator for correlation. Advantageously, the correlator is a cross-correlator or an autocorrelator.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a schematic flowchart of a method;

FIG. 2 is a schematic block diagram of a receiving circuit;

FIG. 3a is a schematic diagram to illustrate the switching; and

FIG. 3b is a schematic diagram of a time sequence of a correlation result.

### DETAILED DESCRIPTION

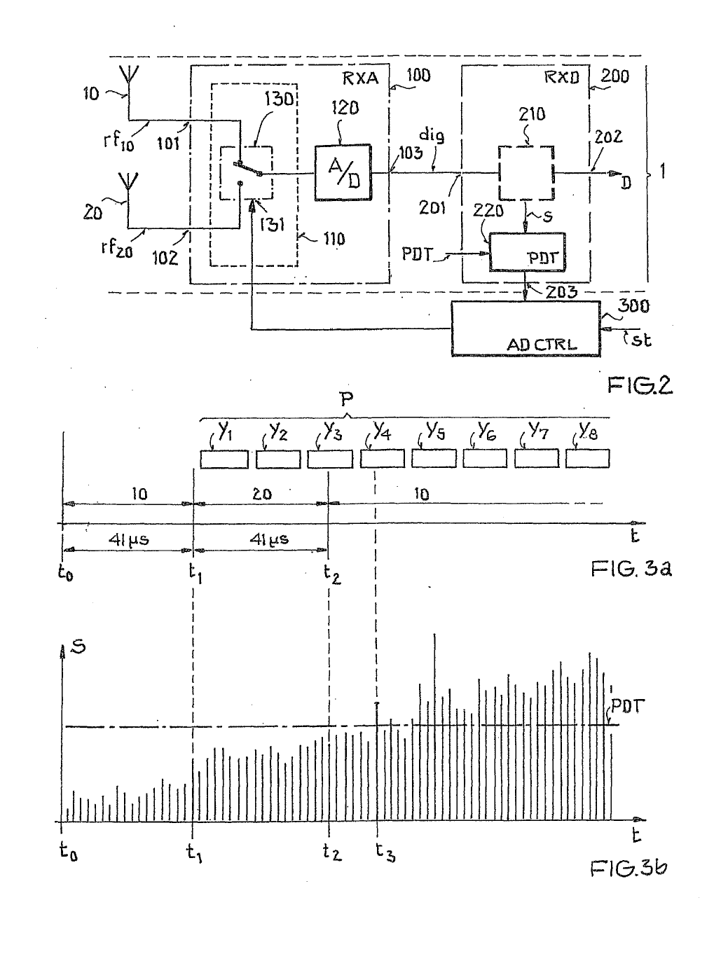

A block diagram of a receiving circuit of a radio network node is shown schematically in FIG. 2. The receiving circuit is connected over a first input 101 to a first antenna 10 and over a second input 102 to a second antenna 20. First input 101 and second input 102 are connected furthermore to a switching device 130 to switch between a first signal rf10, receivable over first antenna 10, and a second signal rf20, receivable over second antenna 20. Switching device 130 may have one or more switching transistors to form the switching function. Switching device 130 in this regard is part of an analog subcircuit 110, which is formed for additional analog functions, such as amplification or filtering.

The signal output by switching device 130 as an input signal reaches an analog-to-digital converter (A/D) 120, which converts the input signal into a digital signal dig and outputs it at output 103. Analog subcircuit 110 and analog-to-digital converter (A/D) 120 are part of an input circuit (RXA) 100 of the receiving circuit. A digital evaluation circuit (RXD) 200 is connected downstream of input circuit 100 in receive path 1. Digital evaluation circuit 200 has a correlator 210 and a digital comparator 220. In addition, the evaluation circuit may have a plurality of additional circuits, which are not shown in FIG. 2 for the sake of a simplified illustration.

The digital signal dig is correlated in correlator 210, which is, for example, an autocorrelator or a cross-correlator, whereby correlator 210 outputs a correlation signal s depending on the correlation. The correlation signal s in this regard is a measure, for example, for the determined matching. The correlation signal s is compared in digital comparator 220 with the threshold PDT, which may be fixed or programmable or can be calculated. An output 203 of comparator 220 is connected to an input of control circuit 300. Control circuit 300 in this regard is formed to control the switching via switching device 130 by means of a switching signal at switch input 131, in that an output of control circuit 300 is connected to switch input 131 of switching device 130.

Digital evaluation circuit 200 has an output 202 connected to correlator 210 to output data D of a frame, which is stored in a memory not shown in FIG. 2. In addition, a monitoring means (not shown in FIG. 2) may be provided, which in the case of complete storage of the data D of a frame generate a control signal st and output it to an input of control circuit 300.

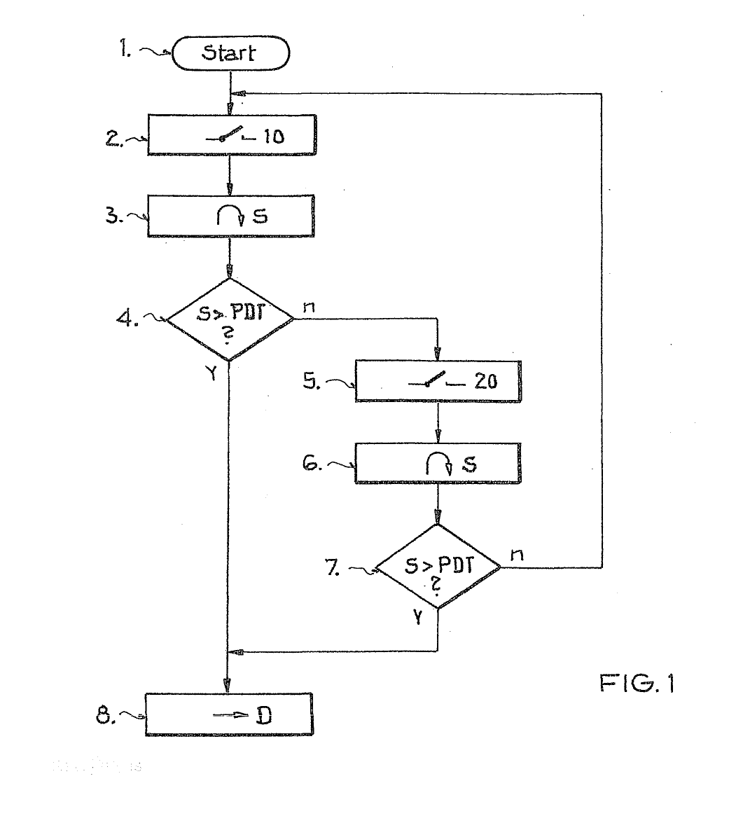

A possible process sequence is described in greater detail hereinafter with reference to a schematic flowchart of the exemplary embodiment of FIG. 1. The sequence is started in a step 1. In step 2, switching device 130 switches to first antenna 10, so that the first signal rf10 is converted as an input signal by analog-to-digital converter 120 into the digital signal dig. The digital signal dig is correlated in step 3 to output a correlation signal s.

In step 4, the correlation signal s is compared with a threshold PDT for a certain time period, for example, of less than 50 μs. If during this time period correlation signal s does not exceed the threshold PDT, switching to second antenna 20 is carried out in step 5 by switching device 130. This has the effect that the second signal rf20 is converted as an input signal by analog-to-digital converter 120 into the digital signal dig. The digital signal dig originating from second antenna 20 is correlated in step 6 to output a correlation signal s. In step 7, the correlation signal s is in turn compared with the threshold PDT for the specific time period, for example, of less than 60 μs. If the correlation signal s during this time period is below the threshold PDT, in step 2 switching to first antenna 10 is again carried out by switching device 130. The steps 2 to 7 therefore cause a continuous switching between first antenna 10 and second antenna 20, provided that the correlation signal s does not exceed the threshold PDT.

If the threshold PDT of the correlation signal s is exceeded in step 4, the switching is stopped and the process is continued in step 8 with the switch position to first antenna 10. In this regard, data D are received. If a frame with data D has been completely received and loaded into a memory, the sequence in steps 2 or 5 is continued (not shown in FIG. 1). The procedure is similar if the threshold PDT is exceeded by correlation signal s in step 5. In this regard, the process is continued in step 8 with the switch position to second antenna 20. In this regard, data D are again received. If a frame with data D has been completely received again and loaded into a memory, the sequence is continued in step 2 or 5 (not shown in FIG. 1).

A preamble is transmitted for correlation. The time period between two switchings is to be shorter thereby than a transmission time for the preamble. Advantageously, the time period between two switchings is shorter than half of the transmission time for the preamble. The time period between two switchings can be different or depend on other parameters or measured values.

An example with a time period of 41 μs between two switchings is shown schematically in FIGS. 3a and 3b. Between time points t0 and t1, switching device 130 is controlled for 41 μs in a switch position corresponding to first antenna 10. Between time points t1 and t2, switching device 130 is controlled for another 41 μs in a switch position corresponding to second antenna 20. Accordingly, in the exemplary embodiment of FIGS. 3a and 3b, switching is performed cyclically with a time period of 41 μs.

Shortly after time t1 of the switching, a preamble P is transmitted by another node. The preamble in the exemplary embodiment of FIG. 3a comprises eight symbols y1, y2, y3, y4, y5, y6, y7, and y8. Due to the independence of the transmitting node and the receiving node of the radio network, the beginning of the transmission of preamble P is not synchronized to the switching times t0, t1, or t2 but is completely random. The time period of 41 μs between two switching time points (t1 and t2) is thereby shorter than the transmission time of three symbols, accordingly shorter than ⅜ of the transmission time for preamble P.

In FIG. 3b, the time sequence of the correlation signal s is shown schematically in relation to the switching time points illustrated in FIG. 3a. The illustration of the correlation signal s begins at time point t0 until time point t1 whereby the correlation signal s does not exceed the threshold PDT. Accordingly, the switching is not stopped and at the next switching time point t1, the switch is made from first antenna 10 to second antenna 20. In fact, the transmission of the preamble begins after time point t2, but second antenna 20 is not set up in such a way that the correlation signal s exceeds the threshold PDT during the receiving by second antenna 20.

Only after the repeated switching to first antenna 10 at time point t2 does the correlation signal s exceed the threshold PDT at time point t3. The switching is stopped at this moment, so that the switch position for first antenna 10 is set up to an interrupt condition. This type of interrupt condition, for example, is a time switch signal or complete loading of the data D of a frame in a memory.

The invention is not limited to the shown embodiment variants in FIGS. 1 through 3b. For example, it is possible to provide a different cycle with, for example, more than 41 μs between two switchings. It is also possible to adjust the time period between two switchings to a receive field strength of the particular antenna 10, 20. The functionality of the receiving circuit according to FIG. 2 or the method according to FIG. 1 can be used especially advantageously for a radio network of industry standard IEEE 802.15.4.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for receiving in a radio network, the method comprising:
switching continuously between a first signal, which is received over a first antenna, and a second signal, which is received over a second antenna, to form an input signal;
converting the input signal into a digital signal;
correlating the digital signal to output a correlation signal;
comparing the correlation signal with a threshold; and
stopping the switching for data reception in a current switch position when the correlation signal exceeds the threshold.

2. The method according to claim 1, wherein a preamble is transmitted for correlation and wherein a time period between two switchings is shorter than a transmission time for the preamble.

3. The method according to claim 2, wherein the time period between two switchings is shorter than half of the transmission time for the preamble.

4. The method according to claim 1, wherein the switching is cyclic.

5. The method according to claim 1, wherein a time period between two switchings is lengthened when a determined received power exceeds an additional threshold.

6. The method according to claim 1, wherein the switching is stopped after the threshold is exceeded until it is determined that the transmitted data are complete.

7. The method according to claim 1, wherein the switching is stopped after the threshold is exceeded depending on a time switch.

8. A receiving circuit of a radio network comprising:
a first input configured to receive a first signal and being connectable to a first antenna;
a second input configured to receive a second signal and being connectable to a second antenna;
a switching device, which is connected to switch between the first signal and the second signal;
an analog-to-digital converter configured to convert the first signal or the second signal into a digital signal;
a synchronization device configured to correlate the digital signal to output a correlation signal;
a comparator configured to compare the correlation signal with a threshold; and
a control circuit, which is connected to the switching device and the comparator.

9. The receiving circuit according to claim 8, wherein the synchronization device has a correlator, a cross-correlator, or an autocorrelator, for correlation.

10. A use of the synchronization device and a comparator of a receiving circuit of a radio network for comparing a result of a correlation with a threshold and to stop continuing switching between at least two signals of different antennas when the result of the correlation exceeds the threshold.
